(19) United States
(12) Patent Application Publication
(10) Pub. No.: US 2017/0011054 A1
(43) Pub. Date: Jan. 12, 2017

(54) INTELLIGENT CACHING IN DISTRIBUTED CLUSTERED FILE SYSTEMS

(71) Applicant: International Business Machines Corporation, Armonk, NY (US)

(72) Inventors: Ramamohan CHENNAMSETTY, Hopewell Junction, NY (US); Anthony T. DESANTIS, Carnegie, PA (US); Avinesh KUMAR, Allahabad (IN); Sandeep R. PATIL, Pune (IN)

(21) Appl. No.: 14/797,076

(22) Filed: Jul. 11, 2015

(51) Int. Cl. G06F 17/30

(52) U.S. Cl. CPC G06F 17/30091; G06F 17/3007

(57) ABSTRACT

Various embodiments intelligently cache data in distributed clustered file systems. In one embodiment, a set of file system clusters from a plurality of file system clusters being accessed by an information processing system is identified. The information processing system resides within one of the plurality of file system clusters and provides a user client with access to a plurality of files stored within the plurality of file system clusters. One or more file sets being accessed by the information processing system are identified for each of the set of file system clusters that have been identified. A set of data access information comprising at least an identifier associated with each of the set of file system clusters and an identifier associated with each of the one or more file sets is generated. The set of data access information is then stored.

### BACKGROUND

The present disclosure generally relates to data storage, and more particularly relates to intelligently caching data in distributed clustered file systems.

Data access in cloud architectures is beginning to center around scale out storage systems. Scale out storage systems are designed to manage vast repositories of information in enterprise cloud computing environments requiring very large capacities and high performance. Scale out storage systems allow applications to access a single file system, storage device, single portion or data, or single file through multiple file servers in a cluster.

### BRIEF SUMMARY

In one embodiment, a method for intelligently caching data in distributed clustered file systems is disclosed. The method comprises identifying a set of file system clusters from a plurality of file system clusters being accessed by an information processing system. The information processing system resides within one of the plurality of file system clusters and provides a user client with access to a plurality of files stored within the plurality of file system clusters. One or more file sets being accessed by the information processing system are identified for each of the set of file system clusters that have been identified. A set of data access information comprising at least an identifier associated with each of the set of file system clusters and an identifier associated with each of the one or more file sets is generated. The set of data access information is then stored.

In another embodiment, an information processing system for intelligently caching data in distributed clustered file systems is disclosed. The information processing system comprises memory and a processor communicatively coupled to the memory. A data access monitor is communicatively coupled to the memory and the processor. The data access monitor is configured to perform a method. The method comprises identifying a set of file system clusters from a plurality of file system clusters being accessed by the information processing system. The information processing system resides within one of the plurality of file system clusters and provides a user client with access to a plurality of files stored within the plurality of file system clusters. One or more file sets being accessed by the information processing system are identified for each of the set of file system clusters that have been identified. A set of data access information comprising at least an identifier associated with each of the set of file system clusters and an identifier associated with each of the one or more file sets is generated. The set of data access information is then stored.

A computer program product for intelligently caching data in distributed clustered file systems is disclosed. The computer program product comprises a computer readable storage medium having program instructions embodied therewith. The program instruction executable by a processor to cause the processor to perform a method. The method comprises identifying a set of file system clusters from a plurality of file system clusters being accessed by an information processing system. The information processing system resides within one of the plurality of file system clusters and provides a user client with access to a plurality of files stored within the plurality of file system clusters. One or more file sets being accessed by the information processing system are identified for each of the set of file system clusters that have been identified. A set of data access information comprising at least an identifier associated with each of the set of file system clusters and an identifier associated with each of the one or more file sets is generated. The set of data access information is then stored.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment according to one embodiment of the present disclosure;

FIG. 2 illustrates various components of an interface node according to one embodiment of the present disclosure;

FIG. 3 illustrate various components of an information processing system within a Network Attached Storage node according to one embodiment of the present disclosure;

FIG. 4 illustrates one example of home clusters and cache clusters within a networking environment according to one embodiment of the present disclosure;

FIG. 5 illustrates one example of a data structure that maintains data access statistics for files sets and clusters according to one embodiment of the present disclosure;

FIG. 6 illustrates one example of a cell node structure definition that can be utilized in the data structure of FIG. 5 according to one embodiment of the present disclosure;

FIG. 7 illustrates one example of a volume node structure definition that can be utilized in the data structure of FIG. 5 according to one embodiment of the present disclosure;

FIG. 8 illustrates one example of a data access information generated by a Network Attached Storage interface node according to one embodiment of the present disclosure;

FIG. 9 is an operational flow diagram illustrating one example of intelligently caching data in distributed clustered file systems according to one embodiment of the present disclosure;

FIG. 10 is an operational flow diagram illustrating another example of intelligently caching data in distributed clustered file systems according to one embodiment of the present disclosure;

FIG. 11 illustrates on example of a cloud computing nodes according to one embodiment of the present disclosure;

FIG. 12 illustrates one example of a cloud computing environment according to one embodiment of the present disclosure; and

FIG. 13 illustrates one example of abstraction model layers according to one embodiment of the present disclosure.

### DETAILED DESCRIPTION

### Operating Environment

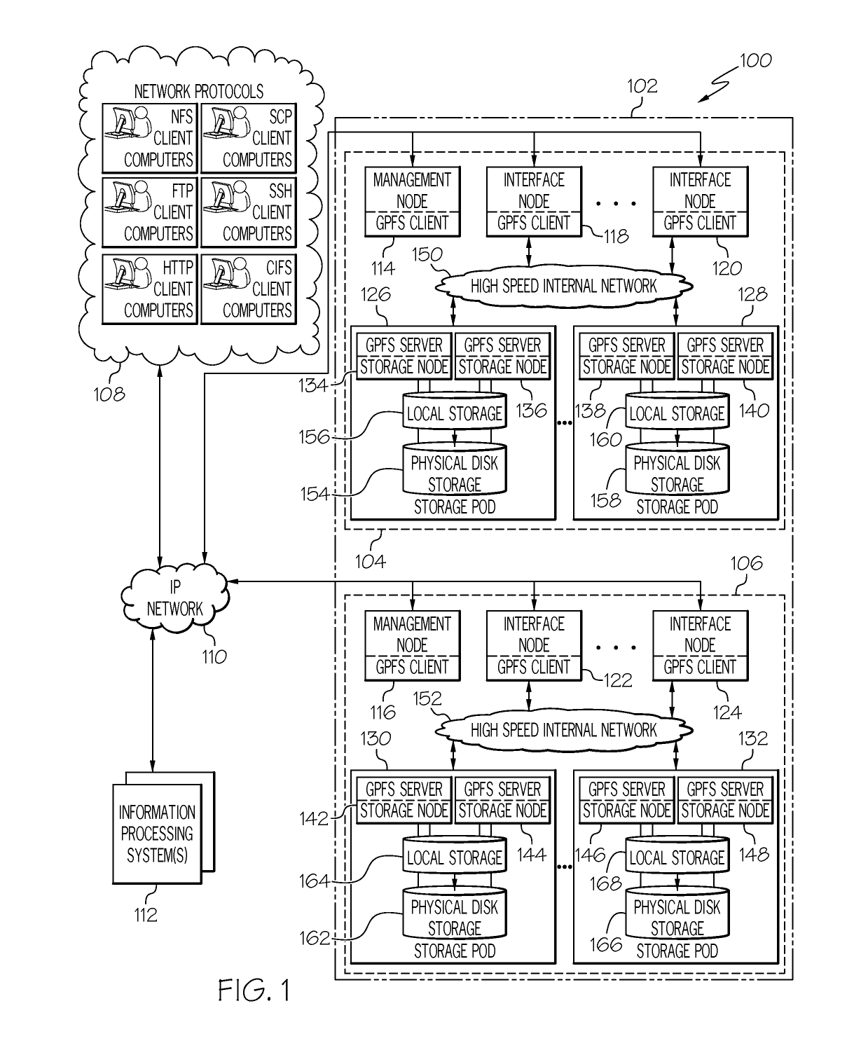

FIG. 1 shows one example of an operating environment 100 for intelligently caching data in distributed clustered file systems. In particular, FIG. 1 shows an operating environment 100 comprising a cloud infrastructure 102 that can be offered by a networked (e.g. cloud) computing storage service provider. In one embodiment, the infrastructure 102 comprises one or more network attached storage (NAS) environments 104, 106 also referred to herein as “NAS environments” 104, 106, “clusters 104, 106”, and “file system clusters 104, 106”. One example of NAS environment is the scale out network attached storage (SONAS™) provided by International Business Machines, which is further discussed in “SONAS Concepts, Architecture, and Planning Guide”: IBM Redbooks, SG24-7963-00, May 2012, and is hereby incorporated by reference in its entirety.

In one embodiment, each NAS environment 104, 106 of the cloud infrastructure 102 104 is a storage scaled out NAS that manages vast repositories of information for enterprise cloud computing clusters requiring very large capacities (e.g., petabytes), high levels of performance, and high availability. Each NAS environment 104, 106 is built using a parallel (clustered) file system such as the IBM General Parallel File System™ (GPFS™), which is a clustered file system that supports scalable and parallel cluster computing. The NAS environments 104, 106 thereby allow applications to access a single file system, storage device, single portion or data, or single file through multiple file servers in a cluster. The multiple NAS environment 104, 106 are presented on the network as a single instance NAS appliance.

Each NAS environment 104, 106 comprises support for client computers utilizing standards-based network protocols 108 which comprise Hypertext Transfer Protocol (HTTP), Network File System (NFS) Protocol, Secure Copy Protocol (SCP), Computer Internet File System (CIFS) Protocol, File Transfer Protocol (FTP), and Secure Shell (SSH) Protocol. Internet Protocol (IP) network 110 provides for connectivity between client computers utilizing protocols 108 and each NAS 104, 106 within the storage cloud infrastructure 102, so that a user can access files residing in each NAS 104, 106 regardless of geographic location. A cloud administrator can utilize an information processing system 112 to access one or more management nodes 114, 116 of the NAS environments 104, 106. Through the management nodes 114, 116 and utilization of the information processing system 112, the administrator can configure, manage, and monitor the cloud infrastructure 102 and its NAS environments 104, 106.

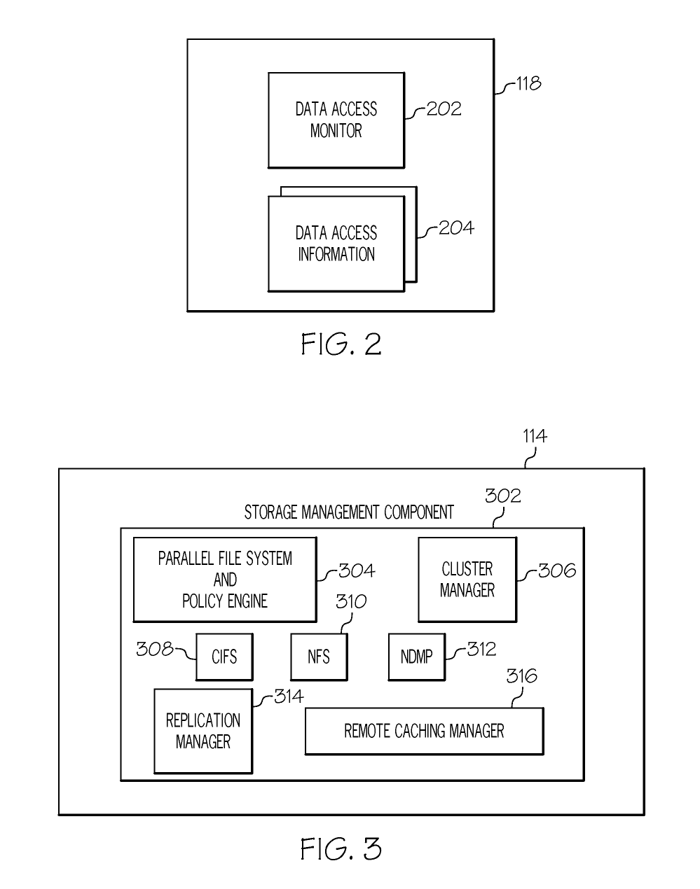

FIG. 1 further shows that each NAS environment 104, 106 comprises a plurality of interface nodes 118 to 124. Interface nodes 118 to 124 provide users access to the data and file services 118 to 124, and can utilize standard protocols 108. The nodes 118 to 124 work together as one to present the image of a common global NAS namespace and data to end users. Interface nodes can also be referred to as “application nodes” since they receive input/output requests from applications. In one embodiment, each interface node 118 to 1124 comprises a data access monitor 202, as shown in FIG. 2. The data access monitor 202 monitors and records data access information 204 identifying which file system clusters are being access by the interface node; how many files from a file set of a specific cluster are being utilized; and the types of operations (e.g., read or write) that are being performed on the file set. The data access monitor 202 transmits this data access information 204 to a centralized information processing system 112 for analysis by a cluster administrator and/or an automated cluster caching agent. The data access information 204 helps a cluster administrator and/or an automated agent identify and select the most widely utilized file sets for wide area network caching in a cache cluster. In one embodiment, a file set is a file system object that is a subtree of a file system namespace that behaves like a separate file system. File sets provide the ability to partition a file system to allow administrative operations at a finer granularity than the entire file system.

Within each NAS environment 104, 106, storage is arranged in storage pods 126 to 132, which each comprises at least two storage nodes 134 to 148, respectively. The storage nodes in a pod work as a clustered pair to manage and present the storage from the storage enclosures to the NAS parallel file system. The interface nodes 118 to 124 are connected to the storage pods 126 to 132 respectively, via a high speed internal network 150, 152. Moreover, interface node 118 and storage nodes 134, 136 function together to provide direct access to physical storage 154 via logical storage pool 156; interface node 120 and storage nodes 138, 140 function together to provide direct access to physical storage 158 via logical storage pool 160; 118 interface node 122 and storage nodes 142, 144 function together to provide direct access to physical storage 162 via logical storage pool 164; and interface node 124 and storage nodes 146, 148 function together to provide direct access to physical storage 166 via logical storage pool 168.

In one embodiment, the management node 114, 116 (and/or one or more other nodes) of each NAS environment 104, 106 comprises a storage management component 302 (also referred to herein as “storage manager 302”), as shown in FIG. 3. In one embodiment, the storage manager 302 provides the delivery of a large petabyte scale NAS server, and allows files to be shared between clients using different file access protocols. The storage manager 302 also comprises file and record locking semantics to enforce data integrity. The storage manager 302, in one embodiment, comprises a parallel file system and policy engine 304, a cluster manager 206, a Common Internet File System (CIFS) 308, Network File System (NFS) 310, Network Data Management Protocol (NDMP) 312, replication manager 314, and a remote caching manager 316.

The parallel file system and policy engine 304 controls how data is stored in the storage pods and retrieved by user clients. The parallel file system is a high-performance clustered file system and provides concurrent high-speed file access to applications executing on multiple nodes of clusters. The cluster manager 306 coordinates resources and ensures data integrity across the multiple nodes in the NAS environment 104, 106. The storage management component 302 supports a clustered version of CIFS 308, which provides shared access to files and other resources on a network. The CIFS service 308 uses the cluster manager 306 to coordinate record locks across multiple interface nodes 118 to 124. The NFS service 310 allows users to access files over a network and utilizes the cluster manager 306 to coordinate its record locks across multiple interface nodes 118 to 124. The NDMP service 312 transports data between the storage nodes 134 to 148 and one or more backup devices. The replication manager 314 provides an integrated asynchronous replication capability that replicates file system data between two NAS environments 102, 104. The remote caching manager 316 performs wide area network caching and provides for a high performance remote dynamic data movement engine within every NAS environment 104, 106 within the infrastructure 102. The remote caching manager 316 is able to locate, manipulate, and move files by criteria within geographically dispersed cloud storage. The remote caching manager 316 provides a wide area network remote caching capability for localizing data automatically to remote users to give the benefits of local input/output speeds. The remote caching manager 316 provides the ability to ingest data remotely then transmit the updates asynchronously back to the source NAS environment 104, 106.

Intelligent Caching In Distributed Clustered File Systems

As discussed above, the storage management component 302 within one or more of the nodes of a NAS environment 104, 106 comprises a remote caching manager 316. The remote caching manager 316 provides a mechanism for exchanging data in a cloud storage environment. Data is exchanged dynamically, immediately, and in an on-demand manner. Exchange occurs between multiple geographically dispersed locations and even between different cloud storage providers. The remote caching manager 316 extends the NAS environment 104, 106 capability for a centrally auto-managed single highly scalable high performance namespace to a truly distributed worldwide and geographically dispersed global namespace. Users see the appearance of a single global NAS storage namespace even though the namespace is actually physically distributed among multiple geographically dispersed locations.

The nodes comprising the remote caching manager 316 appear to be a standard NFS file server in each site. Any NFS clients, proxies, or users in that site can access the storage of the NAS environment 104, 106 through NFS. Also, the nodes comprising the remote caching manager 316 acts as a gateway to all other NAS environments 104, 106 comprising a remote caching manager 316. The remote caching manager 316 presents a common view and common global namespace of all other sites in the cloud storage. With proper authority, all users at an individual site can see the entire single global cloud storage namespace across all sites. Among this cloud storage collection, files are moved and cached in the local site, automatically, on demand. The central locations can also request data ingested at any of the remote sites, or data can be pushed from any site to any other sites.

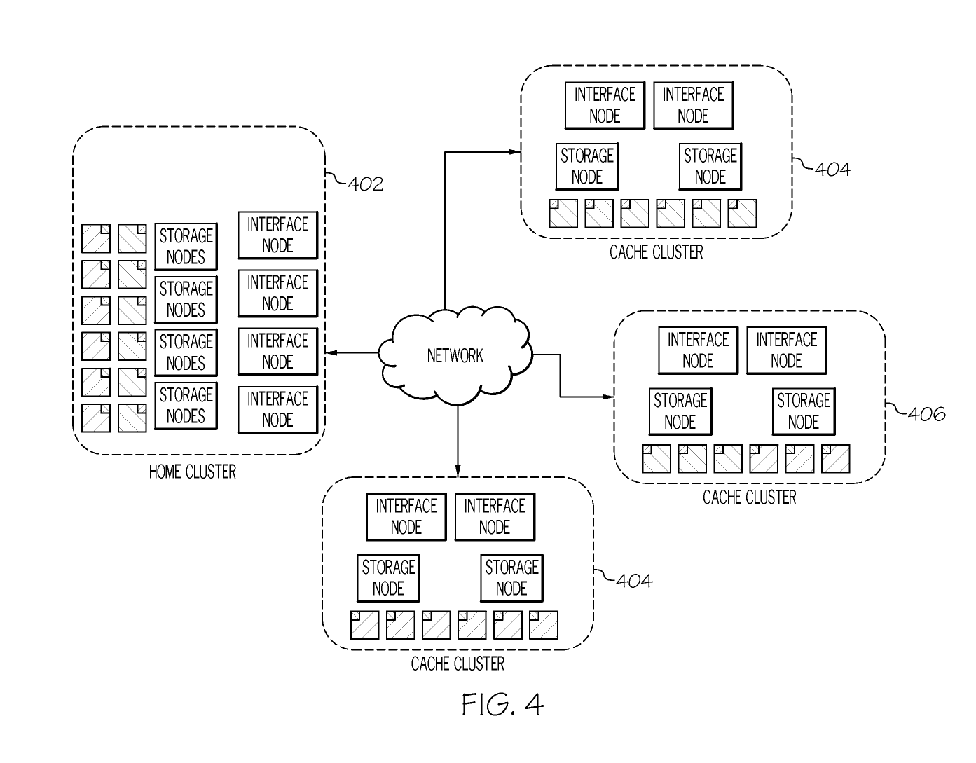

The remote caching manager 316 provides the concept of home clusters and cache clusters. The cache clusters act as front-end wide area network cache access points, which can transparently access the entire collection of NAS environments 104, 106. The home cluster (server) provides the primary storage of data, while the cache cluster (clients) can read or write cache data that is exported to them. For example, FIG. 4 shows one example of an operating environment comprising a home cluster 402 and cache clusters 404, 406, 408. In particular, FIG. 4 shows a first NAS environment 402 configured by the remote caching manager 316 as a home cluster and three additional NAS environments 404, 406, 408 configured as cache clusters. The home cluster 402 provides the primary storage of data, while the cache clusters 404, 406, 408 read or write cache data that is exported to them.

In one embodiment, the home cluster 402 exports a home file set by a standard protocol such as NFS over one or more interface nodes as defined by policies such as users are verified as having permission to access the file from the home cluster. A home is any NFS mount point in the file system. Home designates which site is the owner of the data in a cache relationship. The writing of the data might be at another, different location in the cloud infrastructure 102. However, the home cluster is the owner of the relationships. The NFS mount point can be any file system or file set within a file system within the cloud infrastructure 102. At any one point in time, there is one home location. There can be an unlimited number of cache relationships, and home locations can be changed or moved in coordination with the cache relationships. A cache cluster is the remote site that caches the data. Interface nodes in the cache cluster communicate with the home clusters. The cache cluster presents the virtualized image of all authorized namespaces to the local user as a single virtualized global namespace view. A cache cluster/site creates a file set (cache filed set) and associates it with the home exported data (home file set). A cache cluster can operate in one of the following supported modes: single-writer, read-only, and local-update. There can be multiple cache clusters for a file set exported from the home cluster.

On a read request at the local cache, existing file data at home is pulled into the cache cluster on demand. Multiple interface nodes and multiple NFS connections are used to provide high performance. If the cache cluster is in write mode (for any particular file set, a single writer across the global namespace is supported), new data written to the storage of the cache cluster. This data is asynchronously pushed back to the home cluster, while still maintaining a local copy in the storage of the cache cluster.

Enabling and setting up cache clusters is beneficial, but it comes with a high cost of capital investment. Hence planning for remote caching across clusters spread over geographies needs consideration and planning Customer engagement has shown that the customers having multiple GPFS clusters and multiple access zones (client accessing the data on cluster) spread across geographies face the challenges of analyzing and understanding which of the cluster should be selected for remote caching and in which geographies should the cache cluster be configured. Ideally, one would want to setup remote caching across all the involved geographies, but practical engagement with customers have shown that this is not practical and feasible with respect to cost. Therefore, the following problems need to be addressed: (1) given a particular site which accesses multiple GPFS clusters, if this site is to be made a cache cluster, which cluster should be chosen as the home cluster; and (2) given that the first problem has been solved, then in the selected GPFS home cluster which of the file sets should be nominated as the home file set that is to be cached to the caching file set.

For example, consider a scenario where there are three separate NAS environments/clusters: a Cluster in the U.S.A., a cluster in China, and a cluster in India. A set of interface nodes belonging to the India cluster are spread across farms of machines that access the two clusters separated by geographies, one based in the U.S.A and another one in China. Every interface node in the India cluster uses data from a particular file set belonging to the other two clusters. The administrator of the India cluster wants to improve the performance of the remote cluster data being accessed, but has a limited budget and cannot create cache clusters in both the U.S.A. and China locations. Therefore, the administrator is faced with the following challenges if he/she wants to configure remote caching in the above example: (a) it would be difficult for the administrator to determine for which cluster he/she should configure remote caching since he/she does not know which cluster is utilized the most by the interface nodes in the India cluster; and (b) once the administrator decides on which cluster should be configured as a cache cluster, the administrator would need to determine for which file sets remote caching is to be configured.

Therefore, in one or more embodiments, each interface node 118 to 124 comprises a data access monitor 202, which monitors cluster and file set access by its respective interface node. Based on this monitoring, the data access monitor 202 generates a set of data access information 204 comprising data such as statistics identifying which file system clusters are being access by the interface node; how many files from a file set of a specific cluster are being utilized; and the types of operations (e.g., read or write) that are being performed on the file set. The data access monitor 202 intelligently analyzes the file system cache (within the storage pod) on the interface node to derive the data access information 204. The data access monitor 202 sends the data access information 204 to one or more information processing systems 112 for presentation to a cluster administrator or processing by an automated agent. The cluster administrator or an automated agent utilizes the data access information 204 to identify which clusters should be configured as remote clusters and which file sets should be cached at these remote clusters.

The following illustrates one example of how the data access monitor 202 monitors cluster and file set access, and generates the set of data access information 204 based thereon. It should be noted that this example considers NAS environments/clusters that utilize the Andrew File System (AFS). However, embodiments of this disclosure are not limited to such a file system and other file systems are applicable as well. In this illustrative example, data is locally cached in a NAS environment 104, 106 in an area of storage specified by the administrator (herein referred to as the “cache area”). A caching operation can be performed based on various conditions having occurred or actions having been performed such as when an application running on an application node tries to access data stored in a volume/fileset of a cluster/AFS cell. In this example, the AFS client fetches and stores the data in the cache area and provides access to this cached data to the requesting application.

The cached data is stored in chunks, and each chunk is stored in file referred to as “cache entries” or “Vfile” in the cache area. The file system maintains a file “CacheItems” where the file system stores the following information for each chunk: 1.) file system object identifier (FID), which comprises NAS environment/cluster ID (e.g., AFS cell ID), a unique file set ID (e.g., volume ID), and uniquifier ID, which is a unique identifier identifying a file object in a fileset; 2.) the amount of valid data within the chunk; 3) whether this file is read-only or read-write; and 4.) whether a write operation is being performed for this file. The CacheItems file is a fixed format file and has a header followed by an array of records. The header comprises information regarding the number of cache entries or Vfiles. After the header, the CacheItems file has fixed length record information for all cache entries. For each cache entry, there is the file system object identifier, which can be used to find the NAS environment name (e.g., AFS cell name), file set name (volume name), and the file's inode number using appropriate Remote Procedure Calls (RPCs). This information is sufficient to determine the specific file object in AFS global namespace.

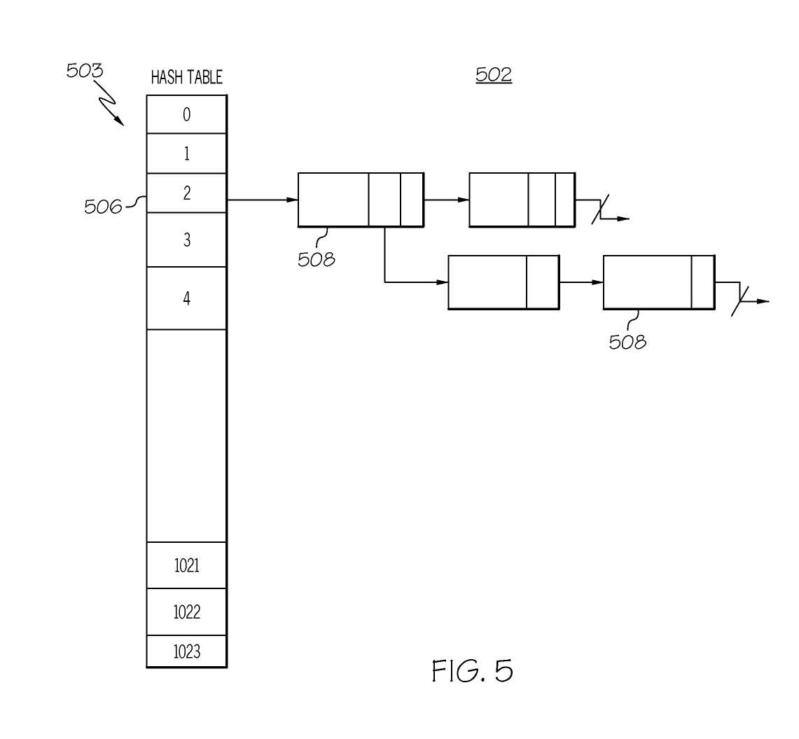

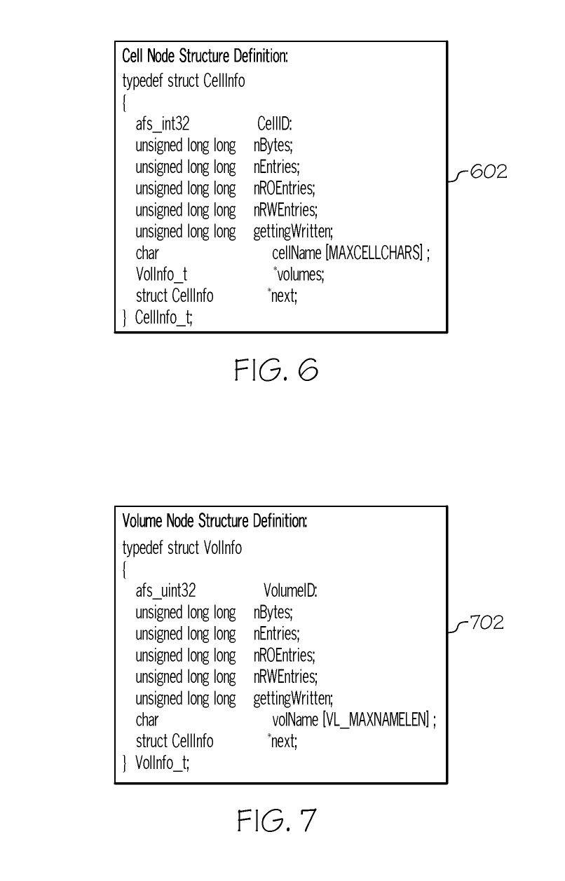

As the data access monitor 202 parses through each record pertaining to cache entries, the data access monitor 202 populates or updates the data structure 502 shown in FIG. 5. In one embodiment, this data structure 502 is a hash structure. The data access monitor 202 analyzes the CacheItems file, which holds a record of information for AFS file IDs (FIDs) of all the files currently in cache. A hash function is used to calculate the index to a corresponding hash table 503 at which a given AFS file ID comprises an entry. In this particular implementation, a hash value is calculated from the AFS cell ID. If the same hash index is obtained for a different AFS cell ID, then another node is chained at the same index as shown in the FIG. 5. This node 504 maintains information at the cell level. FIG. 6 shows one example of a cell node structure definition 602.

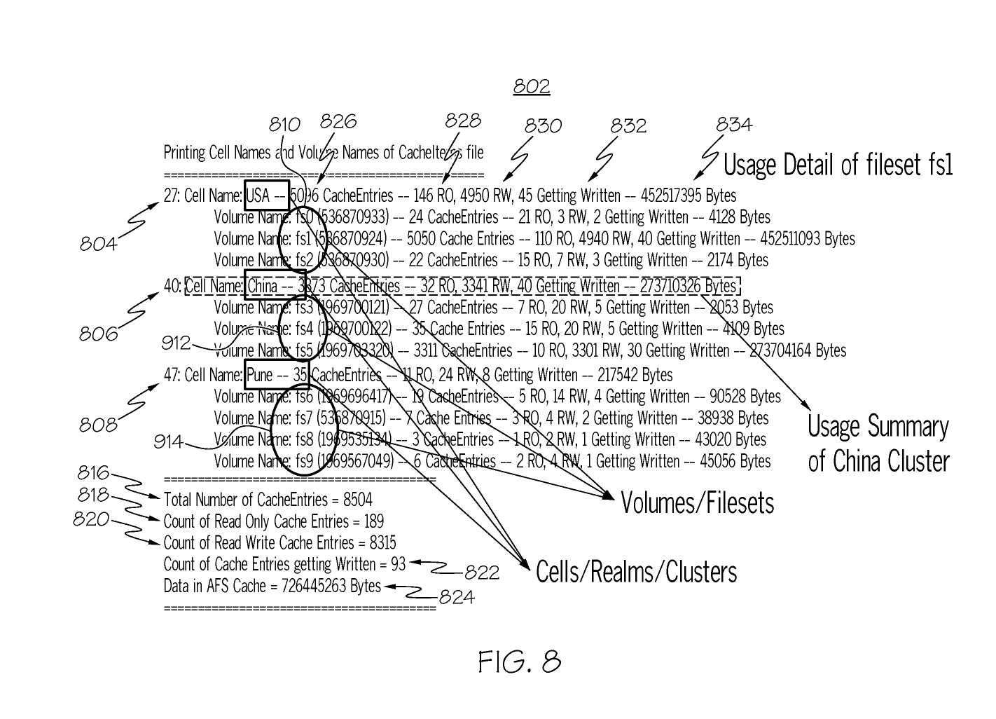

A cell node 504 comprises information such as cell name, total number of bytes currently cached, total number of cache entries, number of cache entries for read-only files, number of cache entries for read-write files, number of cache entries for which a write operation is currently executed, etc. A cell node 504 is associated with a link of nodes for each volume/fileset for the AFS cell for which that are cache entries. These link nodes are referred to as volume nodes 508. FIG. 5 shows volumes nodes 508 as a chain of nodes linked to a cell node 504. The volume node 508 corresponds to a volume/fileset and comprises information such as volume ID, total number of bytes currently cached corresponding to all AFS FIDs related to this volume/fileset, total number of cache entries for all file system objects corresponding to this volume node, total number of read-only cache entries, total number of read-write entries, number of cache entries for which a write operation is currently executed, etc. FIG. 7 shows one example of a volume node structure definition 702.

When an AFS FID is encountered the structure 502 is populated/updated by finding the cell node for the AFS FID in the hash table 503 based on its hash index. Various values are then obtained and/or updated such as the size of the cache entry; increment entry count; depending on type of file for which the cache entry is maintained, increment read-only/read-write/backup entry count; and if this cache entry represents a file on which a write operation is currently being executed on, update gettingWritten count. These statistics are maintained at a cell level, having information collected from all the cache entries belonging to any of the volume nodes of a particular AFS Cell. These statistics can then be sent to one or more of the NAS environment nodes. If a cell node 504 for this FID is not found the hash table 503 has not been updated based on the FID. Therefore, the data access monitor 202 adds a cell node corresponding to this AFS cell in the hash table 503. The data access monitor 202 updates the value(s) discussed above.

The data access monitor 202 then determines the file set name (e.g., volume name) using the file set ID (e.g., volume ID) in the FID stored in the cache entry. The data access monitor 202 checks its data structure 502 to determine if a volume node 508 for the file set associated with the FID exists within the data structure 502. If a volume node does not exist, a volume node 508 is linked to the corresponding cell node 504. FIG. 5 shows a chain of volume nodes 508 corresponding to each file set for a NAS environment node 504 (e.g., cell Node 504) linked to their corresponding node 504.

The data access monitor 202 analyzes the cache entry to obtain various statistics for the file set. Example of statistics obtained/updated from the cache entry include size of cache entry; increment entry count 3) depending on type of file for which the cache entry is maintained, increment read-only/read-write/backup entry count; and if this cache entry represents a file on which a write operation is currently being executed on, update gettingWritten count. These statistics are maintained at a volume/fileset level. The volume node 508 within the data structure 502 is updated with these statistics. It should be noted that, in some embodiments, the CacheItems file (or similar file) is not required. For example, the data access monitor 202 or a user space tool can be configured to work with a kernel extension or module to obtain statistics about file sets cached locally in a NAS environment 104, 106 from the kernel space. The kernel extension or module cab be hooked at the appropriate location to record what files are getting cached or removed from cache for a particular file system.

Once the data access monitor 202 has processed all of the cache entries or a given number of cache entries, the data access monitor 202 processes the stored statistics and generates data access information 204. The data access monitor 202 then transmits the data access information 204 to a central information processing system 112 for presentation to an administrator or processing by an automated agent. FIG. 8 shows one example of data access information 802 generated by a data access monitor 202. In particular, the data access information 204 of FIG. 8 shows that the interface node, which generated the information 204, is accessing data from three clusters: a cluster 804 in the U.S.A., a cluster 806 in China, and a cluster 808 in India (Pune). The output shows that the interface node has accessed file sets 810 fs0, fs1 and fs2 from the U.S.A. cluster 804; file sets 812 fs3, fs4, and fs5 from the China cluster 806; and file sets 814 fs6, fs7, fs8, and fs8 from the India cluster 808.

The data access information 802 provides the total number of cache entries 816 in use by the interface node that generated the information 802; the number of read-only cache entries 818; the number of read-write cache entries 820; the number of cache entries getting written to 822; and the number of bytes of data 824 used by the client for a particular cluster. This usage data is also provided on a per cluster basis as well. The data access information 802 also comprises usage details at the file set level for all file sets accessed by the client (application node) from all accessed clusters. For example, the data access information 802 shows the number of cache entries 826 for each file set; the number of read-only cache entries 828 for each file set; the number of read-write cache entries 830 for each file set; the number of cache entries 832 getting written to for each file set; and the number of bytes of data 834 for each file set.

Based on the data access information 802 shown in FIG. 8, an administrator and/or automated agent for the India cluster that generated the information 802 can conclude that the U.S.A. cluster is highly used (452 MB of data in cache) followed by the China cluster (273 MB of data in cache). By looking at the file set level details for all clusters, the administrator and/or automated agent can see that the client has cached approximately 452 MB of data from file set fs1 belonging to the U.S.A. cluster and approximately 273 MB of data from file set fs5 belonging to the China cluster. Based on these findings, it would be beneficial to configure remote caching at the India cluster for file set fs1 from the USA cluster and for file set fs5 from the China Cluster. Stated differently, since the application node is caching the largest amount of data from file set fs1 in the U.S.A. cluster from as compared to any other file set from any other cluster. Therefore, the U.S.A. cluster is selected as the home cluster in this example and remote caching is setup for file set fs1 at the remaining clusters. Remote caching can also be setup for file set fs5 from the China cluster since this file set has the next highest usage statistics.

It should be noted that there are other advantages of the data access information besides identifying which file sets to remotely cache. For example, the usage pattern derived intelligently from the file system cache over specified intervals helps administrators and users to better tune the configuration parameters file set caching. Also, the data access information also helps determine any file integrity issues faced by interface nodes, as it will show information about what data the application has actually cached-in for a specific file. This is a crucial information to debug distributed files system problems in scenarios where the files system server logs never catch the file integrity issues when they happen on the client cache. Such information helps support teams and developers to analyze the issue and potential problem.

Operational Flow Diagram

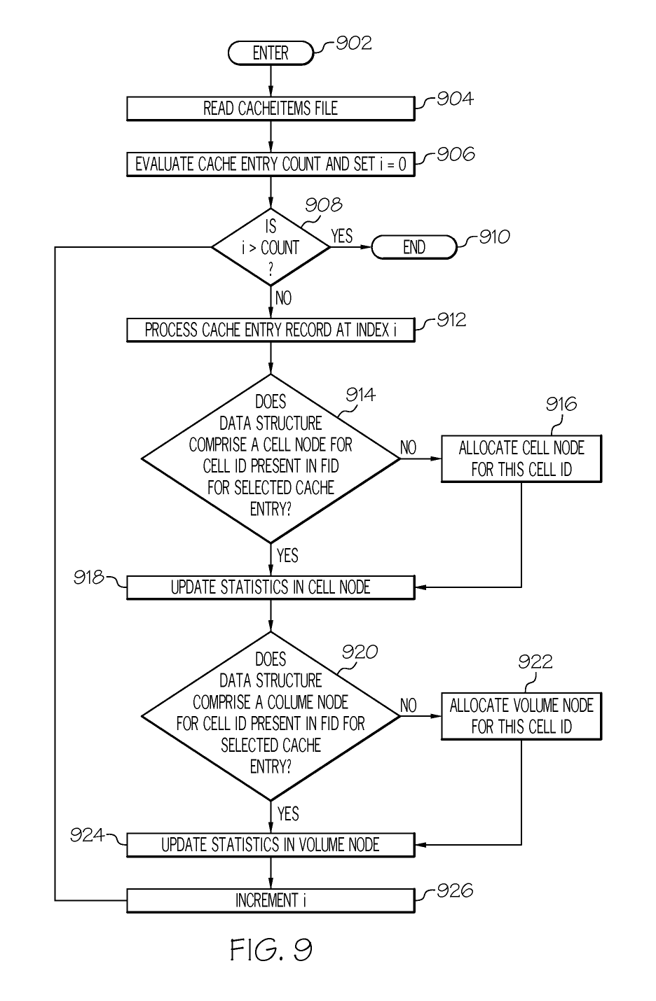

FIG. 9 is an operational flow diagram illustrating one example of intelligently caching data in distributed clustered file systems. The operational flow diagram of FIG. 9 begins at step 902 and flows directly to step 904. The data access monitor 202, at step 904, reads a CacheItems file for a file set. The data access monitor 202, at step 906, evaluates the number of cache entries within the CacheItems file and sets variable i=0. The data access monitor 202, at step 908, determines if it is greater than the number of cache entries. If the result of this determination is positive, the control flow exits at step 910. If the result of this determination is negative, the data access monitor 202, at step 912, processes the cache entry record of the CacheItems file at index i.

The data access monitor 202, at step 914, determines if a data structure for storing data access statistics for a cluster comprises a cell node ID present in the FID for the selected cache entry. If the result of this determination is negative, then the data access monitor 202, at step 916, allocates a cell node for this cell ID. If the result of this determination is positive, the data access monitor 202, at step 918, updates the cell node with statistics associated with the cluster corresponding to the cache entry. The data access monitor 202, at step 920, determines if the data structure comprises a volume node ID present in the FID for the selected cache entry. If the result of this determination is negative, then the data access monitor 202, at step 922, allocates a volume node for this cell ID. If the result of this determination is positive, the data access monitor 202, at step 924, updates the volume node with statistics associated with the file set corresponding to the cache entry. The data access monitor 202, at step 926, increments i and the control flow returns to step 908.

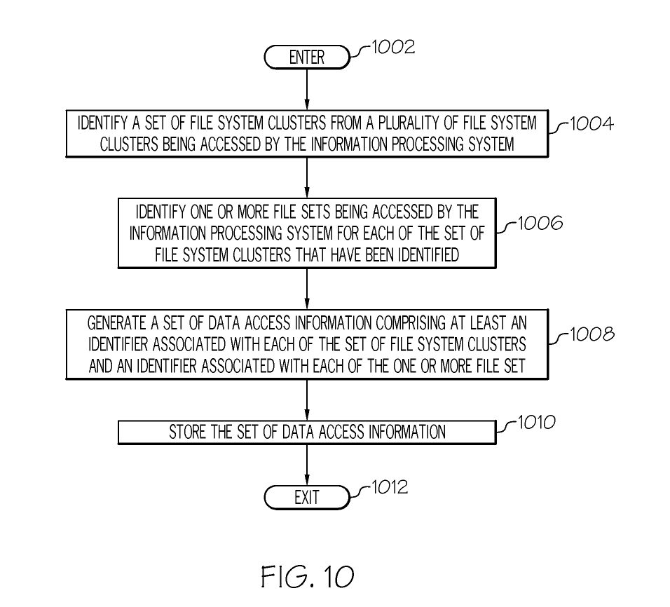

FIG. 10 is an operational flow diagram illustrating one example of intelligently caching data in distributed clustered file systems. The operational flow diagram of FIG. 10 begins at step 1002 and flows directly to step 1004. The data access monitor 202, at step 1004, identifies a set of file system clusters from a plurality of file system clusters being accessed by the information processing system comprising the data access monitor 202. The information processing system resides within one of the plurality of file system clusters and provides a user client with access to a plurality of files stored within the plurality of file system clusters.

The data access monitor 202, at step 1006, identifies one or more file sets being accessed by the information processing system for each of the set of file system clusters that have been identified. The data access monitor 202, at step 1008, generates a set of data access information comprising at least an identifier associated with each of the set of file system clusters and an identifier associated with each of the one or more file sets. The data access monitor 202, at step 1010, stores the set of data access information. The control flow exits at step 1012.

Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned, and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

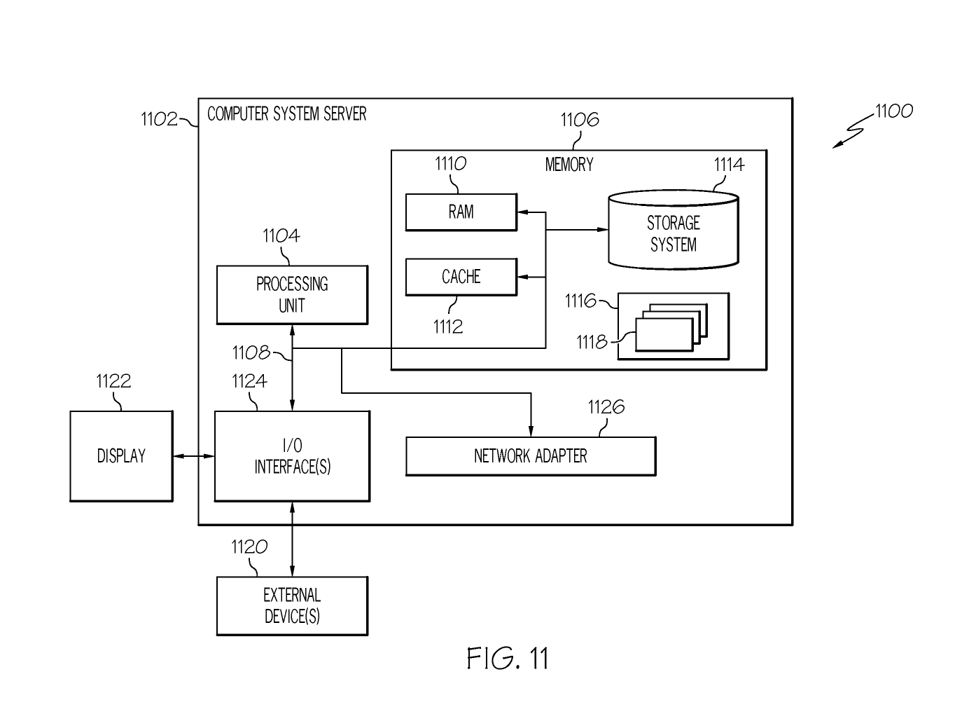

Referring now to FIG. 11, a schematic of an example of a cloud computing node is shown. Cloud computing node 1100 is only one example of a suitable cloud computing node and is not intended to suggest any limitation as to the scope of use or functionality of embodiments of the invention described herein. Regardless, cloud computing node 1100 is capable of being implemented and/or performing any of the functionality set forth hereinabove. In one embodiment, the cloud computing node 1100 is one of the nodes within the NAS environments 104, 106 discussed above.

In cloud computing node 1100 there is a computer system/server 1102, which is operational with numerous other general purpose or special purpose computing system environments or configurations. Examples of well-known computing systems, environments, and/or configurations that may be suitable for use with computer system/server 1102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1102 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 1102 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 1102 in cloud computing node 1100 is shown in the form of a general-purpose computing device. The components of computer system/server 1102 may include, but are not limited to, one or more processors or processing units 1104, a system memory 1106, and a bus 1108 that couples various system components including system memory 1106 to processor 1104. Although not shown in FIG. 11, the data access monitor 202 discussed above with respect to FIG. 2 can reside within the system memory 1106 and/or the processor 1104. This component can also be a separate hardware component as well.

Bus 1108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1102 typically includes a variety of computer system readable media. Such media may be any available media that is accessible by computer system/server 1102, and it includes both volatile and non-volatile media, removable and non-removable media. System memory 1106 can include computer system readable media in the form of volatile memory, such as random access memory (RAM) 1110 and/or cache memory 1112. Computer system/server 1102 may further include other removable/non-removable, volatile/non-volatile computer system storage media. By way of example only, storage system 1114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1108 by one or more data media interfaces. As will be further depicted and described below, memory 1106 may include at least one program product having a set (e.g., at least one) of program modules that are configured to carry out the functions of embodiments of the invention.

Program/utility 1116, having a set (at least one) of program modules 1118, may be stored in memory 1106 by way of example, and not limitation, as well as an operating system, one or more application programs, other program modules, and program data. Each of the operating system, one or more application programs, other program modules, and program data or some combination thereof, may include an implementation of a networking environment. Program modules 1118 generally carry out the functions and/or methodologies of embodiments of the invention as described herein.

Computer system/server 1102 may also communicate with one or more external devices 1120 such as a keyboard, a pointing device, a display 1122, etc.; one or more devices that enable a user to interact with computer system/server 1102; and/or any devices (e.g., network card, modem, etc.) that enable computer system/server 1102 to communicate with one or more other computing devices. Such communication can occur via Input/Output (I/O) interfaces 1124. Still yet, computer system/server 1102 can communicate with one or more networks such as a local area network (LAN), a general wide area network (WAN), and/or a public network (e.g., the Internet) via network adapter 1130. As depicted, network adapter 1126 communicates with the other components of computer system/server 1102 via bus 1108. It should be understood that although not shown, other hardware and/or software components could be used in conjunction with computer system/server 1100. Examples, include, but are not limited to: microcode, device drivers, redundant processing units, external disk drive arrays, RAID systems, tape drives, and data archival storage systems, etc.

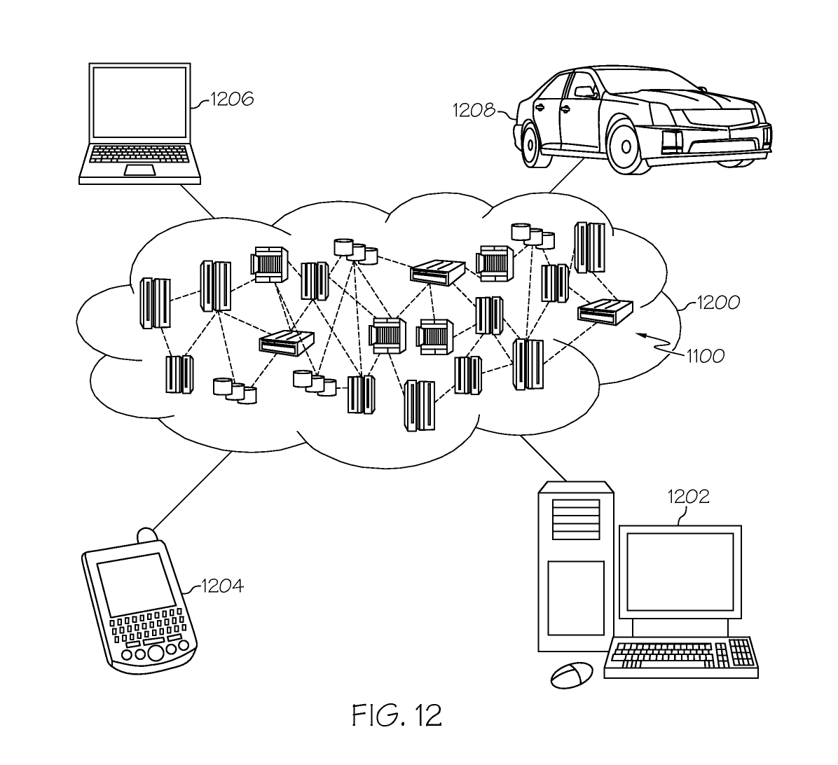

Referring now to FIG. 12, illustrative cloud computing environment 1200 is depicted. As shown, cloud computing environment 1200 comprises one or more cloud computing nodes 1100 with which local computing devices used by cloud consumers, such as, for example, personal digital assistant (PDA) or cellular telephone 1202, desktop computer 1204, laptop computer 1206, and/or automobile computer system 1208 may communicate. Nodes 1100 may communicate with one another. They may be grouped (not shown) physically or virtually, in one or more networks, such as Private, Community, Public, or Hybrid clouds as described hereinabove, or a combination thereof. This allows cloud computing environment 1100 to offer infrastructure, platforms, and/or software as services for which a cloud consumer does not need to maintain resources on a local computing device. It is understood that the types of computing devices 1202-1208 shown in FIG. 12 are intended to be illustrative only and that computing nodes 1100 and cloud computing environment 1200 can communicate with any type of computerized device over any type of network and/or network addressable connection (e.g., using a web browser).

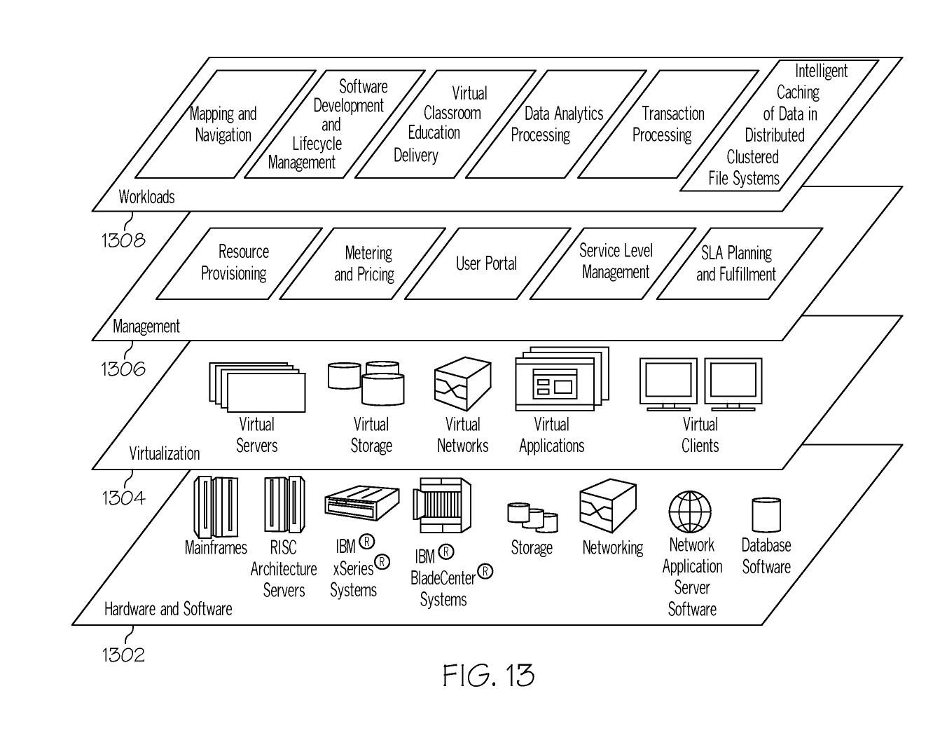

Referring now to FIG. 13, a set of functional abstraction layers provided by cloud computing environment 1200 (FIG. 12) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1302 includes hardware and software components. Examples of hardware components include: mainframes; RISC (Reduced Instruction Set Computer) architecture based servers; storage devices; networks and networking components. In some embodiments, software components include network application server software.

Virtualization layer 1304 provides an abstraction layer from which the following examples of virtual entities may be provided: virtual servers; virtual storage; virtual networks, including virtual private networks; virtual applications and operating systems; and virtual clients.

In one example, management layer 1306 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1308 provides examples of functionality for which the cloud computing environment may be utilized. Examples of workloads and functions which may be provided from this layer include: mapping and navigation; software development and lifecycle management; virtual classroom education delivery; data analytics processing; transaction processing; and intelligent caching of data in distributed clustered file systems.

Non-Limiting Examples

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer maybe connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, with an information processing system, for intelligently caching data in distributed clustered file systems, the method comprising:
identifying, by an information processing system, a set of file system clusters from a plurality of file system clusters being accessed by the information processing system, where the information processing system resides within one of the plurality of file system clusters and provides a user client with access to a plurality of files stored within the plurality of file system clusters;
identifying one or more file sets being accessed by the information processing system for each of the set of file system clusters that have been identified;
generating a set of data access information comprising at least an identifier associated with each of the set of file system clusters and an identifier associated with each of the one or more file sets; and
storing the set of data access information.

2. The method of claim 1, further comprising:
transmitting the set of data access information to an information processing system accessible by an administrator of at least one of the plurality of file system clusters.

3. The method of claim 1, further comprising:
determining a number of files from each of the one or more file sets that are being accessed by the information processing system; and
identifying a type of operation performed on each of the one or more file sets that have been identified.

4. The method of claim 3, wherein the set of data access information comprises the number of files from each of the one or more file sets that are being accessed and the type of operation performed on each of the one or more file sets that have been identified.

5. The method of claim 3, wherein the type of operation comprises at least one of a read-only operation and a read-write operation.

6. The method of claim 1, wherein generating the data access information comprises:
generating, for each of the set of file system clusters, a total count of file set caching instances that occurred at the one of the plurality of file system clusters during a given time interval; and
generating a total count of each of a plurality of operation types performed on file sets cached at the one of the plurality of file system clusters during the given time interval.

7. The method of claim 1, wherein generating the data access information comprises:
generating, for each of the one or more file sets, a total count of instances where the file set was cached at the one of the plurality of file system clusters during a given time interval; and
generating, for each of the one or more file sets, a total count of each of a plurality of operation types performed on the one or more file sets during the given time interval.

8. An information processing system for intelligently caching data in distributed clustered file systems, the information processing system comprising:
memory;
a processor communicatively coupled to the memory; and
a data access manager communicatively coupled to the memory and the processor, the data access manager configured to perform a method comprising:
identifying a set of file system clusters from a plurality of file system clusters being accessed by the information processing system, where the information processing system resides within one of the plurality of file system clusters and provides a user client with access to a plurality of files stored within the plurality of file system clusters;
identifying one or more file sets being accessed by the information processing system for each of the set of file system clusters that have been identified;
generating a set of data access information comprising at least an identifier associated with each of the set of file system clusters and an identifier associated with each of the one or more file sets; and
storing the set of data access information.

9. The information processing system of claim 8, wherein the method further comprises:
transmitting the set of data access information to an information processing system accessible by an administrator of at least one of the plurality of file system clusters.

10. The information processing system of claim 8, wherein the method further comprises:
determining a number of files from each of the one or more file sets that are being accessed by the information processing system; and
identifying a type of operation performed on each of the one or more file sets that have been identified.

11. The information processing system of claim 10, wherein the set of data access information comprises the number of files from each of the one or more file sets that are being accessed and the type of operation performed on each of the one or more file sets that have been identified.

12. The information processing system of claim 8, wherein generating the data access information comprises:
generating, for each of the set of file system clusters, a total count of file set caching instances that occurred at the one of the plurality of file system clusters during a given time interval; and
generating a total count of each of a plurality of operation types performed on file sets cached at the one of the plurality of file system clusters during the given time interval.

13. The information processing system of claim 8, wherein generating the data access information comprises:
generating, for each of the one or more file sets, a total count of instances where the file set was cached at the one of the plurality of file system clusters during a given time interval; and
generating, for each of the one or more file sets, a total count of each of a plurality of operation types performed on the one or more file sets during the given time interval.

14. A computer program product for intelligently caching data in distributed clustered file systems, the computer program product:
a storage medium readable by a processing circuit and storing instructions for execution by the processing circuit for performing a method comprising:
identifying a set of file system clusters from a plurality of file system clusters being accessed by an information processing system, where the information processing system resides within one of the plurality of file system clusters and provides a user client with access to a plurality of files stored within the plurality of file system clusters;
identifying one or more file sets being accessed by the information processing system for each of the set of file system clusters that have been identified;
generating a set of data access information comprising at least an identifier associated with each of the set of file system clusters and an identifier associated with each of the one or more file sets; and
storing the set of data access information.

15. The computer program product of claim 14, wherein the method further comprises:
transmitting the set of data access information to an information processing system accessible by an administrator of at least one of the plurality of file system clusters.

16. The computer program product of claim 14, wherein the method further comprises:
determining a number of files from each of the one or more file sets that are being accessed by the information processing system; and
identifying a type of operation performed on each of the one or more file sets that have been identified.

17. The computer program product of claim 16, wherein the set of data access information comprises the number of files from each of the one or more file sets that are being accessed and the type of operation performed on each of the one or more file sets that have been identified.

18. The computer program product of claim 16, wherein the type of operation comprises at least one of a read-only operation and a read-write operation.

19. The computer program product of claim 14, wherein generating the data access information comprises:
generating, for each of the set of file system clusters, a total count of file set caching instances that occurred at the one of the plurality of file system clusters during a given time interval; and
generating a total count of each of a plurality of operation types performed on file sets cached at the one of the plurality of file system clusters during the given time interval.

20. The computer program product of claim 14, wherein generating the data access information comprises:
generating, for each of the one or more file sets, a total count of instances where the file set was cached at the one of the plurality of file system clusters during a given time interval; and
generating, for each of the one or more file sets, a total count of each of a plurality of operation types performed on the one or more file sets during the given time interval.
